(19) United States
(12) Patent Application Publication
(10) Pub. No.: US 2005/0187131 A1
(43) Pub. Date: Aug. 25, 2005

(54) Granular laundry detergent composition comprising a ternary detersive surfactant system and low levels of, or no, zeolite builders and phosphate builders

(75) Inventors: Alan Thomas Brooker, Newcastle upon (GB); Nigel Patrick Somerville Roberts, Newcastle upon (GB); John Peter Eric Muller, Newcastle upon (GB); Stuart Andrew Caldwell, Northumberland (GB); Mark Allen Smerznak, Tyne & Wear (GB); Nicola Ethel Davidson, Newcastle upon (GB); Kevin Lee Kott, Newcastle upon (GB); Jason Christopher King, Cincinnati, OH (US); Doris Appleby, Newcastle upon (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/050,063

(22) Filed: Feb. 3, 2005

Related U.S. Application Data
(60) Provisional application No. 60/547,034, filed on Feb. 23, 2004.

(51) Int. Cl. C11D 17/00

(52) U.S. Cl. 510/446

(57) ABSTRACT

The present invention relates to a granular laundry detergent composition comprising: (i) from 5 wt % to 55 wt % anionic detersive surfactant; and (ii) from 0.5 wt % to 10 wt % non-ionic detersive surfactant; and (iii) from 0.5 wt % to 5 wt % cationic detersive surfactant; and (iv) from 0 wt % to 4 wt % zeolite builder; and (v) from 0 wt % to 4 wt % phosphate builder.

### CROSS REFERENCE TO RELATED APPLICATION

This application claims the benefit of U.S. Provisional Application No. 60/547,034, filed 23 Feb. 2004.

### FIELD OF THE INVENTION

The present invention relates to granular laundry detergent compositions comprising a ternary detersive surfactant system and low levels of, or no, zeolite builders and phosphate builders.

### BACKGROUND

Granular laundry detergent compositions need to satisfy the only to have a very good fabric-cleaning performance against a wide variety of soil types, and also needs to have very good dispensing and dissolution profiles. However, a dichotomy may exist in that some reformulations of the granular laundry detergent composition to improve its fabric-cleaning performance may worsen its dispensing and dissolution profiles, and vice versa. It is very difficult to improve the cleaning performance, dispensing profile and dissolution profile at the same time.

Anionic detersive surfactants are incorporated into granular laundry detergent compositions in order to provide a good fabric-cleaning benefit. However, the anionic detersive surfactant is capable of complexing with free cations, such as calcium and magnesium cations, that are present in the wash liquor in such a manner as to cause the anionic detersive surfactant to precipitate out of solution, which leads to a reduction in the anionic detersive surfactant activity. In extreme cases, these water-insoluble complexes may deposit onto the fabric resulting in poor whiteness maintenance and poor fabric integrity benefits. This is especially problematic when the laundry detergent composition is used in hard-water washing conditions when there is a high concentration of calcium cations.

The anionic detersive surfactant's tendency to complex with free cations in the wash liquor in such a manner as to precipitate out of solution is mitigated by the presence of builders, such as zeolite builders and phosphate builders, which have a high binding constant with cations such as calcium and magnesium cations. These builders sequester free calcium and magnesium cations and reduce the formation of these undesirable complexes. However, zeolite builders are water-insoluble and their incorporation in laundry detergent compositions leads to poor dissolution of the laundry detergent composition and can also lead to undesirable residues being deposited on the fabric. In addition, detergent compositions that comprise high levels of zeolite builder form undesirable cloudy wash liquors upon contact with water. Whilst phosphate builders allegedly do not have favourable environmental profiles and their use in laundry detergent compositions is becoming less common; for example, due to phosphate legislation in many countries.

There remains a need for a granular laundry detergent composition comprising an anionic detersive surfactant having a good fabric-cleaning performance, especially a good greasy stain cleaning performance, good whiteness maintenance, and very good dispensing and dissolution profiles.

### SUMMARY OF THE INVENTION

The present invention overcomes the above problems by providing a granular laundry detergent composition comprising: (i) from 5 wt % to 55 wt % anionic detersive surfactant; and (ii) from 0.5 wt % to 10 wt % non-ionic detersive surfactant; and (iii) from 0.5 wt % to 5 wt % cationic detersive surfactant; and (iv) from 0 wt % to 4 wt % zeolite builder; and (v) from 0 wt % to 4 wt % phosphate builder.

### DETAILED DESCRIPTION OF THE INVENTION

The granular laundry detergent composition comprises from 5 wt % to 55 wt %, preferably from 5 wt % to 25 wt % anionic detersive surfactant. Preferably, the composition comprises from 6 wt % to 18 wt %, or from 7 wt % to 15 wt %, or from 8 wt % to 12 wt %, or from 8 wt % to 11 wt % or even from 9 wt % to 10 wt % anionic detersive surfactant. The anionic detersive surfactant can be an alkyl sulphate, an alkyl sulphonate, an alkyl phosphate, an alkyl phosphonate, an alkyl carboxylate or any mixture thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched-chain, linear-chain and random-chain alkyl sulphates (AS), typically having the following formula:
CH₃(CH₂)ₙCH₂—OSO₃.M⁺
wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae: 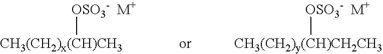
wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

The anionic detersive surfactant is preferably in particulate form, such as an agglomerate, a spray-dried powder, an extrudate, a bead, a noodle, a needle or a flake. The anionic detersive surfactant, or at least part thereof, may be in a co-particulate admixture with a non-ionic detersive surfactant. Preferably, the anionic detersive surfactant, or at least part thereof, is in agglomerate form; the agglomerate preferably comprising at least 20%, by weight of the agglomerate, of an anionic detersive surfactant, more preferably from 25 wt % to 65 wt %, by weight of the agglomerate, of an anionic detersive surfactant. It may be preferred for part of the anionic detersive surfactant to be in the form of a spray-dried powder (e.g. a blown powder), and for part of the anionic detersive surfactant to be in the form of a non-spray-dried powder (e.g. an agglomerate, or an extrudate, or a flake such as a linear alkyl benzene sulphonate flake; suitable linear alkyl benzene sulphonate flakes are supplied by Pilot Chemical under the tradename F90®, or by Stepan under the tradename Nacconol 90G®).

The composition comprises from 0.5 wt % to 10 wt % non-ionic detersive surfactant. Preferably the composition comprises from 1 wt % to 7 wt % or from 2 wt % to 4 wt % non-ionic detersive surfactant. The non-ionic detersive surfactant can be selected from the group consisting of: C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEₓ, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10.

The non-ionic detersive surfactant not only provides additional greasy soil cleaning performance but may also increase the anionic detersive surfactant activity by making the anionic detersive surfactant less likely to precipitate out of solution in the presence of free calcium cations. Preferably, the weight ratio of anionic detersive surfactant to non-ionic detersive surfactant is in the range of less than 8:1, or less than 7:1, or less than 6:1 or less than 5:1, preferably from 1:1 to 5:1, or from 2:1 to 5:1, or even from 3:1 to 4:1.

The non-ionic detersive surfactant, or at least part thereof, can be incorporated into the composition in the form of a liquid spray-on, wherein the non-ionic detersive surfactant, or at least part thereof, in liquid form (e.g. in the form of a hot-melt) is sprayed onto the remainder of the composition. The non-ionic detersive surfactant, or at least part thereof, may be in particulate form, and the non-ionic detersive surfactant, or at least part thereof, may be dry-added to the remainder of the composition. The non-ionic surfactant, or at least part thereof, may be in the form of a co-particulate admixture with a solid carrier material such as carbonate salt, sulphate salt, burkeite, silica or any mixture thereof.

The non-ionic detersive surfactant, or at least part thereof, may be in a co-particulate admixture with either an anionic detersive surfactant or a cationic detersive surfactant. However the non-ionic detersive surfactant, or at least part thereof, is preferably not in a co-particulate admixture with both an anionic detersive surfactant and a cationic detersive surfactant. The non-ionic detersive surfactant, or at least part thereof, may be agglomerated or extruded with either an anionic detersive surfactant or a cationic detersive surfactant.

The composition comprises from 0.5 wt % to 5 wt % cationic detersive surfactant. Preferably the composition comprises from 0.5 wt % to 4 wt %, or from 1% to 3 wt %, or even from 1 wt % to 2 wt % cationic detersive surfactant. Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:
(R)(R¹)(R²)(R³)N⁺X⁻
wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

The cationic detersive surfactant provides additional greasy soil cleaning performance. However, the cationic detersive surfactant may increase the tendency of the anionic detersive surfactant to precipitate out of solution. Preferably, the cationic detersive surfactant and the anionic detersive surfactant are present in the composition in the form of separate particles. This minimises any effect that the cationic detersive surfactant may have on the undesirable precipitation of the anionic detersive surfactant, and also ensures that upon contact with water, the resultant wash liquor is not cloudy. Preferably, the weight ratio of anionic detersive surfactant to cationic detersive surfactant is in the range of from 5:1 to 25:1, more preferably from 5:1 to 20:1 or from 6:1 to 15:1, or from 7:1 to 10:1, or even from 8:1 to 9:1.

The cationic detersive surfactant is preferably in particulate form, such as a spray-dried powder, an agglomerate, an extrudate, a flake, a noodle, a needle, or any combination thereof. Preferably, the cationic detersive surfactant, or at least part thereof, is in the form of a spray-dried powder or an agglomerate. The cationic detersive surfactant may be in the form of a co-particulate admixture with a non-ionic detersive surfactant.

The composition preferably comprises a first surfactant component in particulate form. The first surfactant component is preferably in the form of a spray-dried powder, an agglomerate, an extrudate or a flake. The first surfactant component comprises an anionic detersive surfactant. Preferably, the first surfactant component comprises less than 10%, by weight of the first component, of a cationic detersive surfactant. Preferably, the first surfactant component is free from cationic detersive surfactant. If the first surfactant component is in the form of an agglomerate or an extrudate, then preferably the first surfactant component comprises from 20% to 65%, by weight of the first surfactant component, of an anionic detersive surfactant. If the first surfactant component is in spray-dried form, then preferably the first surfactant component comprises from 10 wt % to 30 wt %, by weight of the first surfactant component, of anionic detersive surfactant. The first surfactant component may be in the form of a co-particulate admixture with a solid carrier material. The solid carrier material can be a sulphate salt and/or a carbonate salt, preferably sodium sulphate and/or sodium carbonate.

The composition preferably comprises a second surfactant component in particulate form. The second surfactant component is preferably in the form of a spray-dried powder, a flash-dried powder, an agglomerate or an extrudate. The second surfactant component comprises a cationic detersive surfactant. Preferably, the second surfactant component comprises less than 10%, by weight of the second surfactant component, of an anionic detersive surfactant. Preferably, the second surfactant component is free from anionic detersive surfactant. If the second surfactant component is in the form of an agglomerate, then preferably the second surfactant component comprises from 5% to 50%, by weight of the second surfactant component, of cationic detersive surfactant, or from 5 wt % to 25 wt % cationic detersive surfactant. The second surfactant component may be in form of a co-particulate admixture with a solid carrier material. The solid carrier material can be a sulphate salt and/or a carbonate salt, preferably sodium sulphate and/or sodium carbonate.

The composition may comprise a third surfactant component. The third surfactant component may be in liquid form (e.g. spray-on and/or hot-melt) or in particulate form such as an agglomerate, a spray-dried powder or an extrudate. The third surfactant component comprises a non-ionic detersive surfactant. The third surfactant component may also comprise either an anionic detersive surfactant or a cationic detersive surfactant; however the third surfactant component will preferably not comprise both an anionic detersive surfactant and a cationic detersive surfactant. The third surfactant component is preferably in the form of a co-particulate admixture with a solid carrier, typically selected from carbonate salt, sulphate salt, burkeite, silica and mixtures thereof. Preferably, the solid carrier material is sodium carbonate and/or sodium sulphate. The third surfactant component may be in the form of a co-particulate admixture with a silicate salt, or even an ultra-fine zeolite having a sub-micrometer primary particle size. The carbonate salt, sulphate salt and/or burkeite can be in micronised particulate form. Alternatively, the third surfactant component can be in the form of a co-particulate admixture with a structurant material, typically selected from the group consisting of: fatty acids; compounds having the formula:
bis((C₂H₅O)(C₂H₄₀)n)(CH₃)—N⁺—CₓH₂ₓ—N⁺—(CH₃)-bis((C₂H₅O)(C₂H₄₀)n)
wherein, n=from 20 to 30, and x=from 3 to 8; compounds having the formula:
sulphonated or sulphated bis((C₂H₅O)(C₂H₄O)n)(CH₃)—N⁺—CₓH₂ₓ—N⁺—(CH₃)-bis((C₂H₅O)(C₂H₄₀)n)
wherein, n=from 20 to 30, and x=from 3 to 8; and mixtures thereof.

The composition comprises from 0 wt % to 4 wt % zeolite builder. The composition preferably comprises from 0 wt % to 3 wt %, or from 0 wt % to 2 wt %, or from 0 wt % to 1 wt % zeolite builder. It may even be preferred for the composition to be free from zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

The composition comprises from 0 wt % to 4 wt % phosphate builder. The composition preferably comprises from 0 wt % to 3 wt %, or from 0 wt % to 2 wt %, or from 0 wt % to 1 wt % phosphate builder. It may even be preferred for the composition to be free from phosphate builder. This is especially preferred if it is desirable for the composition to have a very good environmental profile. Phosphate builders include sodium tripolyphosphate.

The composition may comprise adjunct builders other than the zeolite builder and phosphate builder, especially preferred are water-soluble adjunct builders. Adjunct builders are preferably selected from the group consisting of sodium carbonate, sulphamic acid and/or water-soluble salts thereof, citric acid and/or water soluble salts thereof such as sodium citrate; polymeric polycarboxylates such as co-polymers of acrylic acid and maleic acid, or polyacrylate.

It may be preferred for the composition to comprise very low levels of water-insoluble builders such as zeolite A, zeolite X, zeolite P and zeolite MAP whilst comprising relatively high levels of water-soluble adjunct builders, such as sodium carbonate, sulphamic acid and citric acid.

It may be preferred for the weight ratio of sodium carbonate to zeolite builder to be at least 5:1, preferably at least 10:1, or at least 15:1, or at least 20:1 or even at least 25:1.

The detergent composition may comprise less than 10 wt %, or from 0 wt % to 5 wt %, or less than 4 wt %, or less than 2 wt % silicate salt. It may even be preferred for the detergent composition to be free from silicate salt. Silicate salts include water-insoluble silicates. Silicate salts include amorphous silicates and crystalline layered silicates (e.g. SKS-6). A preferred silicate salt is sodium silicate.

The composition may comprise sulphamic acid and/or water-soluble salts thereof. The water-soluble salts of sulphamic acid can be alkali-metal or an alkaline-earth-metal salts of sulphamate. Other examples of water-soluble salts of sulphamic acid include ammonium sulphamate, zinc sulphamate and lead sulphamate. A preferred water-soluble salt of sulphamic acid is sodium sulphamate. Preferably, the detergent composition comprises sulphamic acid. The detergent composition preferably comprises (on a sulphamic acid basis) from 0.1 wt % to 20 wt % sulphamic acid, and/or water soluble salts thereof, however it may be preferred that the detergent composition comprises from 0.1 wt % to 15 wt %, or from 1 wt % to 12 wt %, or even from 3 wt % to 10 wt % sulphamic acid and/or water-soluble salts thereof. The sulphamic acid typically has the formula:
H₂NSO₃H
The sulphamic acid can be in zwitterionic form when present in the detergent composition; sulphamic acid in zwitterionic form has the formula:
H₃N⁺SO₃⁻
Possibly at least part of, possibly all of, the sulphamic acid is in zwitterionic form when present in the composition, for example as a separate particulate component.

The sulphamic acid can improve the dispensing and disintegration of the detergent composition. It is capable of reacting with a source of carbonate, if present, in an aqueous environment such as the wash liquor in the drum of an automatic washing machine or in the dispensing drawer of an automatic washing machine or some other dispensing device such as a ball (granulette) or a net, to produce carbon dioxide gas. The combination of sulphamic acid and a source of carbonate is an effervescence system that can improve the dispensing performance of the detergent composition. In addition, the extra agitation in the wash liquor provided by this effervescence system can also improve the cleaning performance of the detergent composition.

Sulphamic acid has a very low hygroscopicity, significantly lower than other acids such as citric acid, malic acid or succinic acid; sulphamic acid does not readily pick up water. Sulphamic acid is stable during storage of the detergent composition and does not readily degrade other components of the detergent composition under certain storage conditions such as high humidity. Surprisingly, the sulphamic acid is stable even in the presence of mobile liquid phases, for example non-ionic detersive surfactants. Even more surprisingly, the sulphamic acid does not readily degrade perfumes during storage under high humidity.

Preferably, the sulphamic acid, and/or water-soluble salts thereof, is in particulate form. When the detergent composition is in particulate form, especially a free-flowing particulate form, the sulphamic acid, and/or water-soluble salts thereof, is preferably in particulate form and preferably is incorporated into the detergent composition in the form of dry-added particles, preferably in the form of separate dry-added particles. Alternatively, the sulphamic acid may be in the form of a co-particulate admixture with a source of carbonate, this co-particulate admixture may be produced by methods such as agglomeration (including pressure agglomeration), roller compaction, extrudation, spheronisation, or any combination thereof. Preferably, the sulphamic acid, and/or water-soluble salts thereof, in particulate form has a weight average particle size in the range of from 210 micrometers to 1,200 micrometers, or preferably from 250 micrometers to 800 micrometers. Preferably, the sulphamic acid, and/or water-soluble salts thereof, in particulate form has a particle size distribution such that no more than 35 wt % of the sulphamic acid, and/or water-soluble salts thereof, has a particle size of less than 250 micrometers, preferably no more than 30 wt % of the sulphamic acid, and/or water-soluble salts thereof, has a particle size of less than 250 micrometers, and preferably no more than 35 wt % of the sulphamic acid, and/or water-soluble salts thereof, has a particle size of greater than 1,000 micrometers, preferably no more than 25 wt % of the sulphamic acid, and/or water-soluble salts thereof, has a particle size of greater than 1,000 micrometers.

Sulphamic acid, and/or water-soluble salts thereof, has a superior building capability than other acids such as citric acid, malic acid, succinic acid and salts thereof. Sulphamate, which is either incorporated in the composition or is formed in-situ in the wash liquor by the in-situ neutralisation of sulphamic acid, has a high binding efficiency with free cations (for example, such as calcium and/or magnesium cations to form calcium sulphamate and/or magnesium sulphamate, respectively). This superior building performance due to the presence of sulphamic acid, and/or water-soluble salts thereof, in the detergent composition is especially beneficial when the detergent composition comprises very low levels of, or no, zeolite builders and phosphate builders, when cleaning negatives associated with a high concentration of free calcium and/or magnesium are most likely to occur.

One such cleaning negative associated with high concentrations of free calcium and/or magnesium cations in the wash liquor is poor whiteness maintenance. This is especially true when the detergent composition comprises high levels of carbonate.

It may be preferred for the detergent composition to comprise a carbonate salt, typically from 1 wt % to 50 wt %, or from 5 wt % to 25 wt % or from 10 wt % to 20 wt % carbonate salt. A preferred carbonate salt is sodium carbonate and/or sodium bicarbonate. A highly preferred carbonate salt is sodium carbonate. The carbonate salt, or at least part thereof, is typically in particulate form, typically having a weight average particle size in the range of from 200 to 500 micrometers. However, it may be preferred for the carbonate salt, or at least part thereof, to be in micronised particulate form, typically having a weight average particle size in the range of from 4 to 40 micrometers; this is especially preferred when the carbonate salt, or at least part thereof, is in the form of a co-particulate admixture with a non-ionic detersive surfactant.

High levels of carbonate improve the cleaning performance of the detergent composition by increasing the pH of the wash liquor. This increased alkalinity improves the performance of the bleach, if present, increases the tendency of soils to hydrolyse which facilitates their removal from the fabric, and also increases the rate and degree of ionization of the soils to be cleaned; ionized soils are more soluble and easier to remove from the fabrics during the washing stage of the laundering process. In addition, high carbonate levels improve the flowability of the detergent composition when the detergent composition is in free-flowing particulate form.

However, carbonate anions readily complex with calcium cations in the wash liquor to form calcium carbonate. Calcium carbonate is water-insoluble and can precipitate out of solution in the wash liquor and deposit on the fabric resulting in poor whiteness maintenance. Therefore, it may be preferred if the composition comprises low levels of, or no, carbonate salt. The composition may comprise from 0 wt % to 10 wt % carbonate salt to minimize the negatives associated with the presence of carbonate. However, as described above in more detail, it may be desirable to incorporate higher levels of carbonate salt in the composition. If the composition comprises high levels of carbonate salt, such as at least 10 wt % carbonate salt, then the composition also preferably comprises a source of acid that is capable of undergoing an acid/base reaction with a carbonate anion, such as sulphamic acid, citric acid, malic acid, succinic acid or any mixture thereof. An especially preferred source of acid is sulphamic acid. Preferably, the weight ratio of carbonate salt to the total amount of source of acid in the composition that is capable of undergoing an acid/base reaction with a carbonate anion, is preferably less than 50:1, more preferably less than 25:1, or less than 15:1, or less than 10:1 or even less than 5:1.

In order to minimise the undesirable effects of having too high a concentration of carbonate anions in the wash liquor, the total amount of carbonate anion source in the composition is preferably limited. Preferred carbonate anion sources are carbonate salts and/or percarbonate salts. Preferably, the total amount of carbonate anion source (on a carbonate anion basis) in the composition is between 7 wt % to 14 wt % greater than the theoretical amount of carbonate anion source that is required to completely neutralise the total amount of acid source present in the composition that is capable of undergoing an acid/base reaction with a carbonate anion. By controlling the total amount of carbonate anion source in the composition with respect to the amount of acid source in the composition, in the above described manner, all of the benefits of having of a carbonate anion source in the composition are maximised whilst all of the undesirable negative effects of having too high a concentration of carbonate anions in the wash liquor are minimised.

The composition preferably comprises at least 10 wt % sulphate salt. High levels of sulphate salt can improve the greasy stain removal cleaning performance of the composition. A preferred sulphate salt is sodium sulphate. Sodium sulphate and sulphamic acid are capable of complexing together in the presence of water to form a complex having the formula:
6HSO₃NH₂.5Na₂SO₄.15H₂O
Such complexes are suitable for use herein.

The composition may preferably comprise very high levels of sulphate; the detergent composition typically comprises at least 15 wt % sulphate salt, or even 20 wt % sulphate salt, or even 25 wt % sulphate salt and sometimes even at least 30 wt % sulphate salt. The sulphate salt, or at least part thereof, is typically in particulate form, typically having a weight average particle size in the range of from 60 to 200 micrometers. However, it may be preferred that the sulphate salt, or at least part thereof, is in micronised particulate form, typically having a weight average particle size in the range of from 5 to less than 60 micrometers, preferably from 5 to 40 micrometers. It may even be preferred for the sulphate salt to be in coarse particulate form, typically having a weight average particle size of from above 200 to 800 micrometers.

The composition may preferably comprise less than 60 wt % total combined amount of carbonate and sulphate. The composition may comprise less than 55 wt %, or less than 50 wt %, or less than 45 wt %, or less than 40 wt % total combined amount of carbonate and sulphate.

It may be preferred for the composition to comprise at least 1 wt %, or at least 2 wt %, or at least 3 wt %, or at least 4 wt %, or even at least 5 wt % polymeric polycarboxylates. High levels of polymeric polycarboxylate can act as builders and sequester free calcium ions in the wash liquor, they can also act as soil dispersants and can provide an improved particulate stain removal cleaning benefit. Preferred polymeric polycarboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

It may also be preferred for the composition to comprise a soil dispersant having the formula:
bis((C₂H₅O)(C₂H₄₀)n)(CH₃)—N⁺—CₓH₂ₓ—N⁺—(CH₃)-bis((C₂H₅O)(C₂H₄₀)n)
wherein, n=from 20 to 30, and x=from 3 to 8. Other suitable soil dispersants are sulphonate or sulphated soil dispersants having the formula:
sulphonated or sulphated bis((C₂H₅O)(C₂H₄O)n)(CH₃)—N⁺—CₓH₂ₓ—N⁺—(CH₃)-bis((C₂H₅O)(C₂H₄O)n)
wherein, n=from 20 to 30, and x=from 3 to 8. Preferably, the composition comprises at least 1 wt %, or at least 2 wt %, or at least 3 wt % soil dispersants.

The composition typically comprises adjunct components. These adjunct components include: bleach such as percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid); enzymes such as amylases, carbohydrases, celluloses, laccases, lipases, oxidases, peroxidases, and proteases; suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as polycarboxylates, alkoxylated polyamines and ethoxylated ethyleneimine polymers; and anti-redeposition components such as carboxymethyl cellulose and polyesters. Preferably, the composition comprises less than 1 wt % chlorine bleach and less than 1 wt % bromine bleach. Preferably, the composition is free from deliberately added bromine bleach and chlorine bleach.

The composition can be in any granular form such as an agglomerate, a spray-dried power, an extrudate, a flake, a needle, a noodle, a bead, or any combination thereof. Preferably, the detergent composition is in the form of free-flowing particles. The detergent composition in free-flowing particulate form typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l. During the laundering process, the composition is typically contacted with water to give a wash liquor having a pH of from above 7 to 11, preferably from 8 to 10.5.

The composition may be made by any suitable method including agglomeration, spray-drying, extrusion, mixing, dry-mixing, liquid spray-on, roller compaction, spheronisation or any combination thereof.

In a second embodiment of the present invention, a granular laundry detergent composition is provided, which comprises a detersive surfactant, wherein the composition upon contact with water at a concentration of 9.2 g/l and at a temperature of 20° C., forms a transparent wash liquor having (i) a turbidity of less than 500 nephelometric turbidity units; and (ii) a pH in the range of from 8 to 12. Preferably, the resultant wash liquor has a turbidity of less than 400, or less than 300, or from 10 to 300 nephelometric turbidity units. The turbidity of the wash liquor is typically measured using a H1 93703 microprocessor turbidity meter. A typical method for measuring the turbidity of the wash liquor is as follows: 9.2 g of composition is added to 1 litre of water in a beaker to form a solution. The solution is stirred for 5 minutes at 600 rpm at 20° C. The turbidity of the solution is then measured using a H1 93703 microprocessor turbidity meter following the manufacturer's instructions.

### EXAMPLES

### Example 1

Aqueous slurry composition.

| | % w/w |
|---|---|
| | Aqueous |
| Component | slurry |
| A compound having the following general structure: | 1.23 |
| bis((C₂H₅O)(C₂H₄O)n)(CH₃)—N⁺—CₓH₂ₓ—N⁺—(CH₃)— | |
| bis((C₂H₅O)(C₂H₄O)n), wherein n = from 20 to 30, and | |
| x = from 3 to 8, or sulphated or sulphonated variants thereof | |
| Ethylenediamine disuccinic acid | 0.35 |
| Brightener | 0.12 |
| Magnesium sulphate | 0.72 |
| Acrylate/maleate copolymer | 6.45 |
| Linear alkyl benzene sulphonate | 11.92 |
| Hydroxyethane di(methylene phosphonic acid) | 0.32 |
| Sodium carbonate | 4.32 |
| Sodium sulphate | 47.48 |
| Soap | 0.78 |
| Water | 25.89 |
| Miscellaneous | 0.42 |
| Total Parts | 100.00 |

Preparation of a Spray-Dried Powder.

An aqueous slurry having the composition as described above is prepared having a moisture content of 25.89%. The aqueous slurry is heated to 72° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The spray-dried powder has a moisture content of 1.0 wt %, a bulk density of 427 g/l and a particle size distribution such that 95.2 wt % of the spray-dried powder has a particle size of from 150 to 710 micrometers. The composition of the spray-dried powder is given below.

SPRAY-DRIED POWDER COMPOSITION.

| | % w/w |
|---|---|
| | Spray- |
| | dried |
| Component | powder |
| A compound having the following general structure: | 1.65 |
| bis((C₂H₅O)(C₂H₄O)n)(CH₃)—N⁺—CₓH₂ₓ—N⁺—(CH₃)— | |
| bis((C₂H₅O)(C₂H₄O)n), wherein n = from 20 to 30, and | |
| x = from 3 to 8, or sulphated or sulphonated variants thereof | |
| Ethylenediamine disuccinic acid | 0.47 |
| Brightener | 0.16 |
| Magnesium sulphate | 0.96 |
| Acrylate/maleate copolymer | 8.62 |
| Linear alkyl benzene sulphonate | 15.92 |
| Hydroxyethane di(methylene phosphonic acid) | 0.43 |
| Sodium carbonate | 5.77 |
| Sodium sulphate | 63.43 |
| Soap | 1.04 |
| Water | 1.00 |
| Miscellaneous | 0.55 |
| Total Parts | 100.00 |

Preparation of a Cationic Detersive Surfactant Particle.

The cationic surfactant particle is made on a 14.6 kg batch basis on a Morton FM-50 Loedige. 4.5 kg of micronised sodium sulphate and 4.5 kg micronised sodium carbonate is premixed in the mixer. 4.6 kg of 40% active mono-C₁₂₋₁₄ alkyl mono-hydroxyethyl di-methyl quaternary ammonium chloride (cationic surfactant) aqueous solution is added to the micronised sodium sulphate and micronised sodium carbonate in the mixer whilst both the main drive and the chopper are operating. After approximately two minutes of mixing, a 1.0 kg 1:1 weight ratio mix of micronised sodium sulphate and micronised sodium carbonate is added to the mixer as a dusting agent. The resulting agglomerate is collected and dried using a fluid bed dryer on a basis of 2500 l/min air at 100-140° C. for 30 minutes. The resulting powder is sieved and the fraction through 1400 μm is collected as the cationic surfactant particle. The composition of the cationic surfactant particle is as follows:
15% w/w mono-C₁₂₋₁₄alkyl mono-hydroxyethyl di-methyl quaternary ammonium chloride
40.76% w/w sodium carbonate
40.76% w/w sodium sulphate
3.48% w/w moisture and miscellaneous
   Preparation of a Non-Ionic Detersive Surfactant Particle.

The non-ionic detersive surfactant particle is made on a 25 kg batch basis using a Im diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C., and the mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7) 75.6% w/w sodium sulphate
   Preparation of a Granular Laundry Detergent Composition in Accordance with the Present Invention.

10.15 kg of the spray-dried powder of example 1, 1.80 kg of the cationic detersive surfactant particle of example 1, 2.92 kg of the non-ionic detersive surfactant particle of example 1 and 10.13 kg (total amount) of other individually dosed dry-added material are dosed into a Im diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition in accordance with
the present invention.

| | % w/w |
|---|---|
| | granular |
| | laundry |
| | detergent |
| Component | composition |
| Spray-dried powder of example 1 | 40.61 |
| 91.6 wt % active linear alkyl benzene sulphonate flake | 2.96 |
| supplied by Stepan under the tradename Nacconol 90G ® | |
| Sulphamic acid (mixed grade) supplied by Rhodia | 7.50 |
| Sodium carbonate (coarse grade) | 7.90 |
| Sodium carbonate (micronised grade) | 1.87 |
| Sodium percarbonate (having from 12% to 15% active | 13.78 |
| AvOx) | |
| Photobleach particle | 0.01 |
| Enzymes | 0.67 |
| Tetraacetyl ethylene diamine agglomerate (92 wt % active) | 4.07 |
| Suds suppressor agglomerate (11.5 wt % active) | 0.41 |
| Acrylate/maleate copolymer particle (95.7 wt % active) | 0.27 |
| Green/Blue carbonate speckle | 0.47 |
| Cationic detersive surfactant particle of example 1 | 7.18 |
| Non ionic detersive surfactant particle of example 1 | 11.67 |
| Solid perfume particle | 0.63 |
| Total Parts | 100.00 |

### Example 2

Aqueous slurry composition.

| | % w/w |
|---|---|
| Component | Aqueous slurry |
| Ethylenediamine disuccinic acid | 0.40 |
| Brightener | 0.13 |
| Magnesium sulphate | 0.83 |
| Acrylate/maleate copolymer | 7.42 |
| Cationic surfactant | 3.57 |
| Hydroxyethane di(methylene phosphonic acid) | 0.37 |
| Sodium sulphate | 44.67 |
| Sodium chloride | 10.63 |
| Soap | 0.90 |
| Water | 29.81 |
| Miscellaneous | 1.26 |
| Total Parts | 100.00 |

Preparation of a Spray-Dried Powder.

An aqueous slurry having the composition as described above is prepared having a moisture content of 29.81%. The aqueous slurry is heated to a temperature of from 65° C. to 80° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The composition of the resultant spray-dried powder is described below.

Spray-dried powder composition.

| | % w/w Spray- |
|---|---|
| Component | dried powder |
| Ethylenediamine disuccinic acid | 0.57 |
| Brightener | 0.19 |
| Magnesium sulphate | 1.17 |
| Acrylate/maleate copolymer | 10.47 |
| Cationic surfactant | 5.03 |
| Hydroxyethane di(methylene phosphonic acid) | 0.52 |
| Sodium sulphate | 63.00 |
| Sodium chloride | 15.00 |
| Soap | 1.27 |
| Water | 1.00 |
| Miscellaneous | 1.78 |
| Total Parts | 100.00 |

Preparation of a Non-Ionic Detersive Surfactant Particle.

The non-ionic detersive surfactant particle is made on a 25 kg batch basis using a Im diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C.; and the mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7) 75.6% w/w sodium sulphate
   Preparation of an Anionic Detersive Surfactant Particle.

The linear alkyl benzene sulphonate particle is made on a 14 kg batch basis on a Morton FM-50 Loedige. 7.84 kg micronised sodium sulphate and 2.70 kg micronised sodium carbonate are first added to the mixer while the main drive and chopper are operating. Then 3.46 kg linear alkyl benzene sulphonate paste (78 wt % active) is added to the mixer and mixed for 2 minutes to produce a mixture. The resulting mixture is collected and dried using a fluid bed dryer on a basis of 2500 l/min air at 100-140° C. for 30 minutes to produce the anionic detersive surfactant particle. The composition of the anionic detersive surfactant particle is as follows:
20% w/w linear alkyl benzene sulphonate
20% w/w sodium carbonate
58% w/w sodium sulphate
2% w/w miscellaneous and water
   Preparation of a Granular Laundry Detergent Composition in Accordance with the Present Invention.

10.15 kg of the spray-dried powder of example 2, 2.26 kg of the non-ionic detersive surfactant particle of example 2, 8.5 kg of the anionic detersive surfactant particle of example 2 and 4.09 kg (total) of other individually dosed dry-added material are dosed into a Im diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition in accordance with
the present invention.

| | % w/w granular |
|---|---|
| | laundry detergent |
| Component | composition |
| Spray dried powder of example 2 | 40.61 |
| Sulphamic acid (mixed grade) supplied by Rhodia | 2.50 |
| Percarbonate (having from 12% to 15% active AvOx) | 8.72 |
| Enzymes | 0.46 |
| TAED agglomerate (92% active) | 2.70 |
| Suds suppressor agglomerate (11.5% active) | 0.55 |
| Acrylate/maleate copolymer particle (95.7% active) | 0.89 |
| Anionic detersive surfactant particle of example 2 | 34.00 |
| Non-ionic detersive surfactant particle of example 2 | 9.05 |
| Solid perfume particle | 0.52 |
| Total Parts | 100.00 |

### Example 3

Example 1 is repeated except that di-methyl mono-hydroxyethyl mono-C₁₀ quaternary ammonium chloride replaced the mono-C₁₂₋₁₄alkyl mono-hydroxyethyl di-methyl quaternary ammonium chloride in the cationic detersive surfactant particle.

### Example 4

Example 1 is repeated except that 2.5%, by weight of the composition, of citric acid is dry-added instead of 7.5 wt % sulphamic acid, and the amount of dry-added sodium percarbonate is 10 increased from 13.78% to 18.78% by weight of the composition.

### Example 5

Example 1 is repeated except that 3.75%, by weight of the composition, of citric acid is dry-added, and the amount of dry-added sulphamic acid is reduced from 7.5% to 3.75% by 15 weight of the composition.

### Example 6

Example 1 is repeated except that the following cationic detersive surfactant particle was used instead of the cationic detersive surfactant agglomerate of example 1:

Cationic Detersive Surfactant Particle of Example 6.

9.9% w/w di-methyl mono-hydroxyethyl mono-C₈₋₁₀ quaternary ammonium chloride.
44.55% w/w micronised sodium carbonate having a weight average particle size of 8 micrometers.
44.55% w/w micronised sodium sulphate having a weight average particle size of 11 micrometers.
1% w/w water.

### Example 7

Aqueous slurry.

| | % w/w |
|---|---|
| Component | Aqueous slurry |
| Ethylenediamine disuccinic acid | 0.35 |
| Brightener | 0.12 |
| Magnesium sulphate | 0.72 |
| Acrylate/maleate copolymer | 6.45 |
| Linear alkyl benzene sulphonate | 11.92 |
| Hydroxyethane di(methylene phosphonic acid) | 0.32 |
| Sodium carbonate | 4.32 |
| Sulphamic acid (mixed grade) from Rhodia | 2.00 |
| Sodium sulphate | 46.72 |
| Soap | 0.78 |
| Water | 25.89 |
| Miscellaneous | 0.41 |
| Total Parts | 100.00 |

Preparation of a Spray-Dried Powder.

An aqueous slurry having the composition as described above is prepared having a moisture content of 25.89%. The aqueous slurry is heated to a temperature of from 65° C. to 80° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. During this process, the sulphamic acid is neutralised to the sodium salt form by sodium carbonate. Fine material (<0.15 mm) is elutriated with the exhaust the exhaust air in the spray-drying tower and collected in a post tower containment system. The composition of the resultant spray-dried powder is described below.

Spray-dried powder.

| | % w/w |
|---|---|
| Component | Spray-dried powder |
| Ethylenediamine disuccinic acid | 0.47 |
| Brightener | 0.16 |
| Magnesium sulphate | 0.96 |
| Acrylate/maleate copolymer | 8.62 |
| Linear alkyl benzene sulphonate | 15.92 |
| Hydroxyethane di(methylene phosphonic acid) | 0.43 |
| Sodium carbonate | 4.31 |
| Sodium sulphamate | 3.28 |
| Sodium sulphate | 62.41 |
| Soap | 1.04 |
| Water | 1.00 |
| Miscellaneous | 1.40 |
| Total Parts | 100.00 |

Preparation of a Granular Laundry Detergent Composition in Accordance with the Present Invention.

10.15 kg of the spray-dried powder of example 7, 2.86 kg of the non-ionic detersive surfactant particle of example 1, 1.5 kg of the cationic detersive surfactant particle of example 1 and 10.49 kg (total amount) of other separately dosed dry-added material are dosed into a Im diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition in accordance
with the present invention.

| | % w/w |
|---|---|
| | granular |
| | laundry |
| | detergent |
| Component | composition |
| Spray-dried powder of example 7 | 40.61 |
| 91.6 wt % active linear alkyl benzene sulphonate flake | 3.20 |
| supplied by Stepan under the tradename Nacconol 90G ® | |
| Citric acid | 2.50 |
| Sodium carbonate | 17.11 |
| Sodium percarbonate (having from 12% to 15% active | 12.45 |
| AvOx) | |
| Enzymes | 0.46 |
| TAED agglomerate (92% Active) | 3.8 |
| Suds suppressor agglomerate (11.5% active) | 0.55 |
| Acrylate/maleate copolymer Particle (95.7% active) | 0.89 |
| Green/blue carbonate speckle | 0.47 |
| Cationic detersive surfactant particle of example 1 | 6.00 |
| Non-ionic detersive surfactant particle of example 1 | 11.44 |
| Solid perfume particle | 0.52 |
| Total Parts | 100.00 |

All documents cited in the detailed description of the invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A granular laundry detergent composition comprising:
(i) from 5 wt % to 55 wt % anionic detersive surfactant; and
(ii) from 0.5 wt % to 10 wt % non-ionic detersive surfactant; and
(iii) from 0.5 wt % to 5 wt % cationic detersive surfactant; and
(iv) from 0 wt % to 4 wt % zeolite builder; and
(v) from 0 wt % to 4 wt % phosphate builder.

2. A composition according to claim 1, wherein the weight ratio of anionic detersive surfactant to non-ionic detersive surfactant is less than 8:1.

3. A composition according to claim 1, wherein the composition comprises:
(i) a first surfactant component in particulate form comprising an anionic detersive surfactant; and
(ii) a second surfactant component in particulate form comprising a cationic detersive surfactant.

4. A composition according to claim 3, wherein the first surfactant component comprises less than 10%, by weight of the first surfactant component, of a cationic detersive surfactant.

5. A composition according to claim 3, wherein the second surfactant component comprises less than 10%, by weight of the second surfactant component, of an anionic detersive surfactant.

6. A composition according to claim 1, wherein at least part of the non-ionic detersive surfactant is in the form of a co-particulate admix with a solid carrier material.

7. A composition according to claim 1, wherein part of the anionic detersive surfactant is in the form of a spray-dried powder, and wherein part of the anionic detersive surfactant is in the form of a non-spray-dried powder.

8. A composition according to claim 1, wherein the composition comprises sodium carbonate, and wherein the weight ratio of sodium carbonate to zeolite builder is at least 15:1.

9. A composition according to claim 1, wherein the composition comprises less than 4 wt % silicate salt.

10. A composition according to claim 1, wherein the composition is free from zeolite builder.

11. A composition according to claim 1, wherein the composition is free from phosphate builder.

12. A composition according to claim 1, wherein the composition comprises sulphamic acid and/or water-soluble salts thereof.

13. A composition according to claim 1, wherein the composition comprises from 10 wt % to 25 wt % carbonate salt.

14. A composition according to claim 1, wherein the composition the comprises carbonate salt and sulphamic acid, and wherein if the composition comprises more than 10 wt % carbonate salt then the weight ratio of carbonate salt to sulphamic acid is less than 5:1.

15. A composition according to claim 1, wherein the composition comprises:
(i) a carbonate anion source; and
(ii) an acid source that is capable of undergoing an acid/base reaction with a carbonate anion,
wherein the total amount of carbonate anion source, on a carbonate anion basis, in the composition is between 7 wt % to 14 wt % greater than the theoretical amount of carbonate anion source that is required to completely neutralise the total amount of acid source present in the composition that is capable of undergoing an acid/base reaction with a carbonate anion.

16. A composition according to claim 1, wherein the composition comprises carbonate salt in micronised particulate form.

17. A composition according to claim 1, wherein the composition comprises at least 3 wt % polymeric polycarboxylate.

18. A composition according to claim 1, wherein the composition comprises from 8 to 12 wt % anionic detersive surfactant.

19. A composition according to claim 1, wherein the composition comprises from 2 to 4 wt % non-ionic detersive surfactant.

20. A composition according to claim 1, wherein the composition comprises from 1 to 2 wt % cationic detersive surfactant.

21. A composition according to claim 1, wherein the anionic detersive surfactant is selected from the group consisting of: C₁₀₋₁₃ linear alkylbenzene sulphonate (LAS); linear or branched, substituted or unsubstituted C₁₂₋₁₈ alkyl sulphate; and mixtures thereof.

22. A composition according to claim 1, wherein the non-ionic detersive surfactant is a linear or branched, substituted or unsubstituted C₈₋₁₈ alkyl ethoxylated alcohol having an average ethoxylation degree of from 1 to 10.

23. A composition according to claim 1, wherein the cationic detersive surfactant is a mono-alkyl mono-hydroxyethyl di-methyl quaternary ammonium chloride.

24. A composition according to claim 1, wherein the composition comprises a soil dispersant having the formula:
bis((C₂H₅O)(C₂H₄O)n)(CH₃)—N⁺—CₓH₂ₓ—N⁺—(CH₃)-bis((C₂H₅O)(C₂H₄O)n)
wherein, n=from 20 to 30, and x=from 3 to 8.

25. A composition according to claim 1, wherein the composition comprises a soil dispersant having the formula:
sulphonated or sulphated bis((C₂H₅O)(C₂H₄O)n)(CH₃)—N⁺—CₓH₂ₓ—N⁺—(CH₃)-bis((C₂H₅O)(C₂H₄O)n),
wherein, n=from 20 to 30, and x=from 3 to 8.

26. A granular detergent composition comprising a detersive surfactant, wherein the composition upon contact with water at a concentration of 9.2 g/l and at a temperature of 20° C., forms a transparent wash liquor having:
(i) a turbidity of less than 500 nephelometric turbidity units; and
(ii) a pH in the range of from 8 to 12.
